(19) United States
(12) Patent Application Publication
(10) Pub. No.: US 2022/0292420 A1
(43) Pub. Date: Sep. 15, 2022

(54) Survey and Result Analysis Cycle Using Experience and Operations Data

(71) Applicant: SAP SE, Walldorf (DE)

(72) Inventors: Peter Eberlein, Malsch (DE); Volker Driesen, Heidelberg (DE)

(21) Appl. No.: 17/198,794

(22) Filed: Mar. 11, 2021

(51) Int. Cl. G06Q 10/06; G06F 8/65

(52) U.S. Cl. CPC G06Q 10/06313; G06F 8/65

(57) ABSTRACT

Embodiments implement a survey and result analysis cycle combining user experience and software operations data. A central survey engine receives from a survey designer, a configuration package specifying one or more of the following survey attributes: survey questions; operational data relevant to the survey for collection; rules; a target user group; and a survey triggering event. In response, the survey engine collects applicable operational data from software being evaluated, determines the actual users to be targeted by the survey, and promulgates the survey. Feedback from the survey is received and stored as a package including both the experience data (e.g., survey questions/responses) and operational data (e.g., specific operational data collected from the software that is relevant to the survey questions). This package is sent to a vendor to assist in analyzing the experience of the user of the software, and also to potentially devise valuable questions for a follow-up survey.

### BACKGROUND

Unless otherwise indicated herein, the approaches described in this section are not prior art to the claims in this application and are not admitted to be prior art by inclusion in this section.

Requesting and obtaining accurate and detailed feedback from users of a software application, can be important for planning evolution of the next version to meet consumer expectations more closely. Conventionally, such feedback data has been collected by a high-level feedback option embedded within the application and posing some generic questions.

Alternatively, feedback has been collected through a questionnaire-style evaluation administered separately from the software application—e.g., as a distinct survey emailed on occasion to registered users.

### SUMMARY

Embodiments relate to apparatuses and methods implementing a survey and result analysis cycle using both user experience and software operations data. A central survey engine receives from a survey designer, a configuration package specifying one or more of the following survey attributes: survey questions; operational data relevant to the survey for collection; rules; a target user group; and a survey triggering event. In response, the survey engine collects applicable operational data from software being evaluated, determines the actual users to be targeted by the survey, and promulgates the survey. Feedback from the survey is received and stored as a package including both the experience data (e.g., survey questions/responses) and operational data (e.g., specific operational data collected from the software that is relevant to the survey questions). This package is then sent to a vendor to assist in analyzing the experience of the user of the software, and also to potentially devise valuable questions for a follow-up survey.

Particular embodiments define an application and methods to design and execute user feedback surveys including experience data (referred to herein as X Data) relating to operational data (referred to herein as O Data) of the software being evaluated. Collection of this information supports product evolution of the software being evaluated.

Surveys and associated metadata are dynamically injected into the software being evaluated for user attention, without requiring separate lifecycle events (e.g., upgrading the software to a new version release). The surveys are checked for relevance (for example depending on customer configuration), and duly collect operational data to support at least the following operations.

1. Target user groups for the survey can be identified based upon criteria such as usage of the software, user roles, user profiles, and survey participation history. 2. Survey questions can be adjusted based upon the specific situation in the system, thereby enriching questions with concrete operational data that offers more context to survey participants. 3. Relevant operational data is included in the same package with the submitted survey data, affording a vendor deeper insights into user experience from the correlation of X+O data.

Embodiments thus provide software vendors with new abilities for shaping the evolution of their products to better meet customer demands and expectations. Embodiments allow the promulgation of a more fine-tuned survey—one that matches the situation of the user and ensures against too many surveys being sent to the same users, and too many questions (especially non-relevant questions) being asked. By virtue of the survey and result analysis cycle afforded by embodiments, a survey can be designed by a product manager with tailored questions to exactly defined specialist consumer groups.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified block diagram of a system according to an exemplary embodiment.

FIG. 4 shows a screenshot of an exemplary unfilled survey.

FIG. 5 shows a screenshot of an exemplary filled-in survey.

FIG. 6 illustrates hardware of a special purpose computing machine according to an embodiment that is configured to implement a survey and result analysis cycle.

FIG. 7 illustrates an example computer system.

### DETAILED DESCRIPTION

Described herein are methods and apparatuses that implement a survey and result analysis cycle utilizing experience and operational data. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

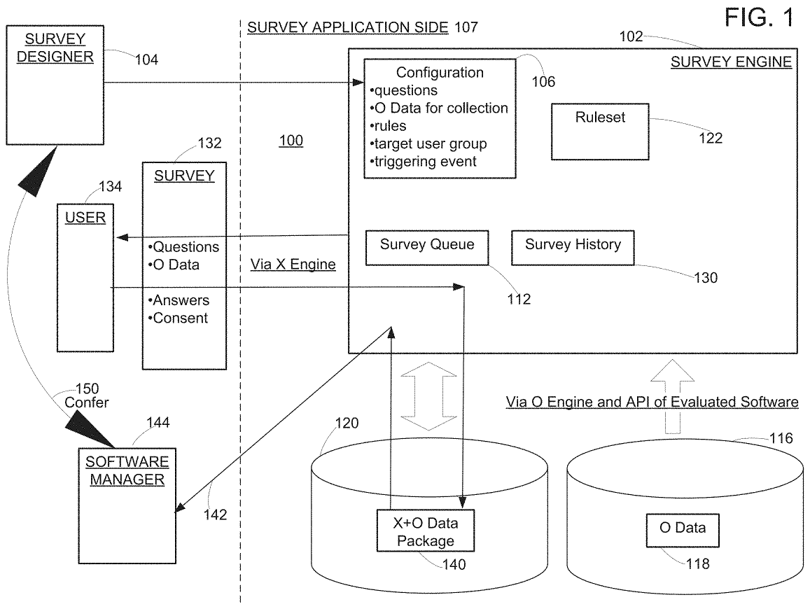

FIG. 1 shows a simplified view of an example system that is configured to implement a survey result and analysis cycle. Specifically, system 100 comprises a central survey engine 102 that is in communication with a survey designer 104.

The survey designer creates a configuration package 106 for a survey, and communicates that configuration package to the coordination engine. The configuration package may comprise one or more of:
survey questions,
particular operational data query definitions for collection in connection with the survey questions,
rules to apply to fine-tune the survey questions,
the target user group for the survey, and
the event triggering the survey to be sent to users.

The application 107 participating in the “X+0 survey service”, downloads the configuration package. In particular, the survey engine stores the new configuration received from a download area, and adds the new survey to the survey queue 112.

The survey engine reads the survey from the survey queue. Based upon the specific operational data identified in the configuration package, the coordination engine calls the underlying operational data storage medium 116 with the configuration, in order to specify which operational data 118 is to be read from the software being evaluated.

This reading of relevant operational data may be performed via a separate operational engine (O Engine). That operational engine calls an Application Program Interface (API) of the evaluated software, or executes SQL statements.

An operational engine may further perform one or more of the following functions:
compute statistics, and/or
anonymize data.

Upon receiving the operational data, the survey engine stores that data in the nontransitory storage medium 120. Then, the survey engine produces relevant information to create the survey, and promulgate same to users of the software in order to obtain feedback.

As part of this process, the survey engine may first assess if the survey is to be communicated at all. For example, no communication of the survey could be appropriate where the questions are not relevant to a current version of the software, etc.

Second, the coordination engine determines the appropriate target user group for the survey. This target group determination may be based upon:
the particular operational data (selected based upon the configuration file), and
rules taken from the configuration file and evaluated by execution with reference to a ruleset 122.

Third, the survey engine computes the survey questions.

Returning to determination of a target user group, the survey history 130 may be evaluated to either:
specify a target user group matching the user group of a previous survey (if this is configured by the designer), or
create a randomly selected user group excluding users having been presented several surveys in the past.
   This user group determination procedure is defined by the survey designer and executed according to the ruleset.

The survey and the target user group are stored in the survey history 130. Then, working potentially via a separate experience engine (X engine), the tailored survey 132 is promulgated to the software users 134 upon occurrence of the event specifically designated by the designer—e.g.:
“particular process completion event”;
“UI used event”;
a random time;
other.

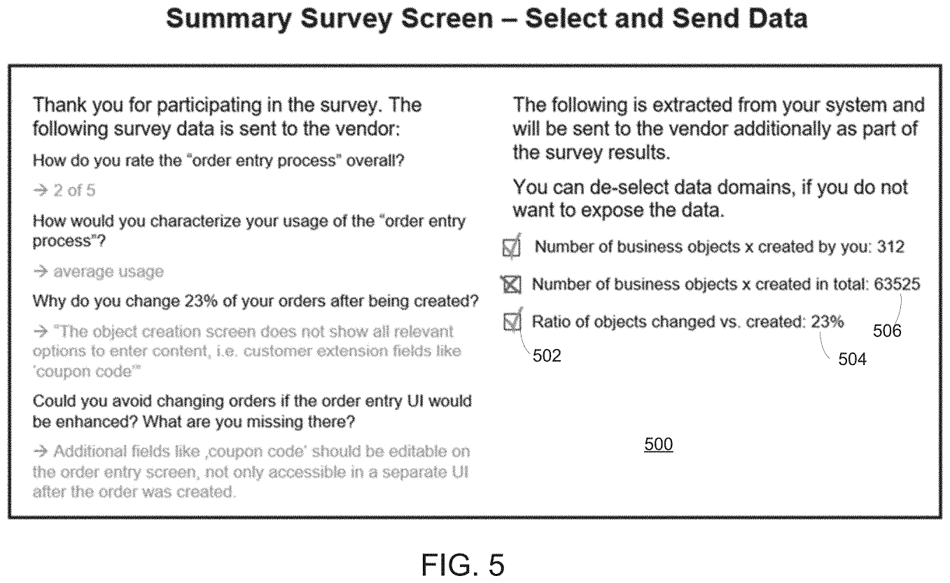

Upon receiving the survey, the software users fill out the survey (or decline to do so). The users review the operational data presented with the survey (and to be returned with the survey result), and select/de-select those data records to be returned. As shown in the exemplary survey screen of FIG. 5 (discussed later below), user consent may be given to return the operational data, and for the vendor to evaluate that returned operational data.

Upon satisfaction of a condition (e.g., defined minimum number of users completing the survey; defined maximum time is reached; other), the survey engine creates the data package 140 comprising both experience data (e.g., survey questions and answers) and particular operational data relevant to that experience data (as determined by the configuration package).

Next, the survey engine sends 142 the data package to manager(s) 144 of the software product — also referred to herein as the vendor. Once a certain amount of feedback has been received, product manager(s) can:
review the survey results (experience data),
correlate that experience data with the operational data returned by the user, and
assess feedback.

Such processing of the survey results can afford software product managers valuable insight into the future of development for the software product. The survey feedback can also provoke the manager to confer 150 with the survey designer in order to create a new or follow-up survey, thereby initiating another survey and result analysis cycle.

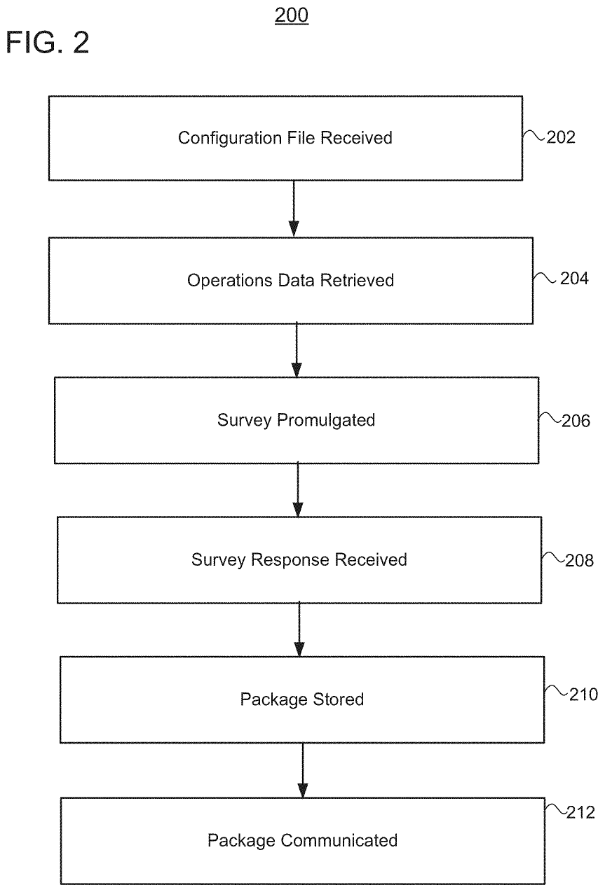

FIG. 2 is a flow diagram of a method 200 of implementing a survey and response cycle according to an embodiment. At 202 a configuration file is received from a survey designer.

At 204, referencing a type of operational data contained in the configuration file, operations data is retrieved from a software application. At 206, a survey including the operations data is promulgated to a user.

At 208 a survey response is received from the user. At 210, a package comprising the survey question, the survey response, and the operations data is stored in a non-transitory computer readable storage medium.

At 212, the package is communicated as feedback to a manager of the software application.

Systems and methods for implementing a survey and result analysis cycle according to embodiments, may avoid one or more issues associated with conventional approaches. In particular, embodiments allow for the design, promulgation, and receipt of survey responses after release of a particular application version. Thus, the opportunity to conduct accurate and relevant surveys is not contingent upon the occurrence of particular software lifecycle events (e.g., new version releases), but rather can take place at any time.

Embodiments further allow tailoring a promulgated survey to the exact situation that the customer is facing. This avoids potential annoyance to users with survey questions that are not relevant to the particular user environment.

Embodiments also provide for the collection of relevant operational data. This relevant operational data and the survey result data are collected together and sent as a bundle as feedback to the software vendor. Accordingly, vendor analysis of the survey result can be specifically informed by the accompanying operational data reflecting the situation of the particular survey respondent.

Further details regarding a survey and result analysis cycle implemented according to various embodiments, are now provided in connection with the following example.

### EXAMPLE

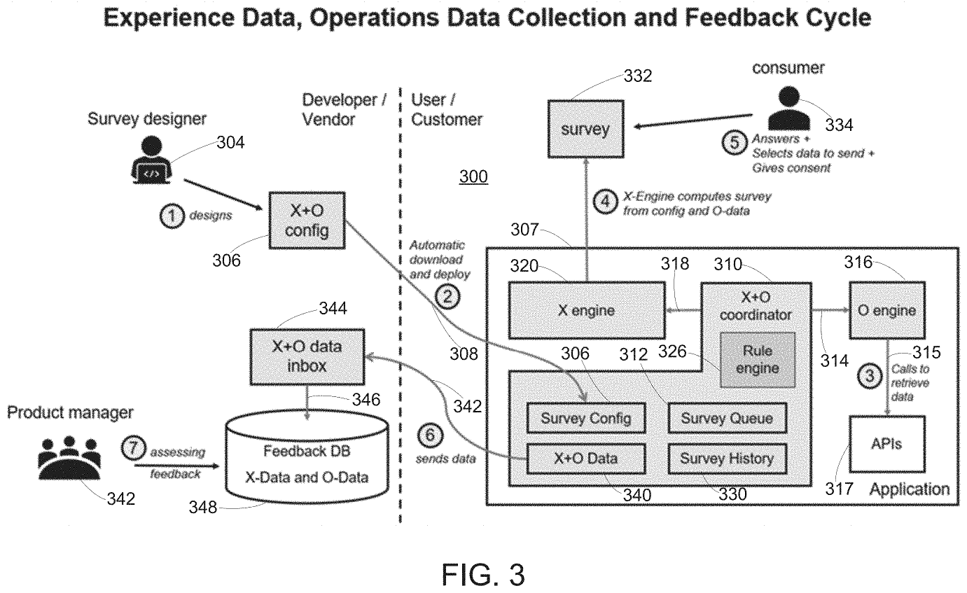

FIG. 3 shows a simplified block diagram illustrating a system 300 to collect experience data (X Data) and operations data (O Data) to implement a feedback cycle according to an exemplary embodiment. This exemplary system includes an X+O coordinator 310.

This X+O coordinator extends applications to run custom-tailored surveys and collect correlated operational data. The X+O coordinator can be configured to determine particular operational data (O Data) to collect, and determine those survey questions to ask of which user. The X+O coordinator can tailor-fit survey questions to a specific customer situation, and then send to the vendor the combined set of survey answers correlated to that operations data.

An initial use of O Data read from the system, is to tailor the survey to the particular situation of the users of the software. This survey-tailoring aspect comprises at least the following two functions:
identify users the survey is sent to;
tailor the questions of the survey to the situation of those users.

The O Data is used to filter and fine-tune survey questions and to correlate with survey answers. Such correlation may result in one or more of the following outcomes.
1. Do not show survey at all (e.g., because the process related to the survey is not relevant to the users and their situations).
2. Filter out survey questions (e.g., because selected questions are not relevant to and/or cannot be answered by the user, or because a regional setting is being evaluated and certain questions are not relevant for certain regions).
3. Adjust survey questions to customer O Data. For example, if the ratio of “change orders” to “orders created” is high, the survey question can be:
   “Why do you need to change the orders this often?”.
   Survey question adjustment can also be customer process related. Specifically, some attributes may not be available at survey creation time, or there may be a User Interface (UI) deficit such as hard-to-find attributes of which most users are unaware.

Then, the users are identified who are asked to participate in the survey.
1. The users may be selected based upon one or more of the following considerations:
their role (e.g., in the org.chart),
usage of a certain functionality,
creator of data, and
other criteria.

Such other criteria may be configured beforehand by the survey designer to direct the questionnaire to the desired target audience (e.g., a customer may have many data records but there are “occasional users” and “power users” and the survey targets “power user” for this particular survey).

2. There may be a stored history indicating those who had been the target of a former survey. Users can be selected based upon this saved history—e.g. as “the same group” (for follow-up surveys), or new random group (to avoid annoying the same users with too many surveys).

3. The user can then be determined if the survey is sent unrelated to work of the user in the system, or if the survey is shown related to an action in the system (e.g., if a process is completed or a certain UI had been used).

A second use of O Data, is to collect from the system those data records which shall later be evaluated in combination with X Data. For this purpose, the bundle of X+O Data is sent to the vendor, allowing interpretation of the survey with context knowledge on the customer situation.

As part of this interpretation by the vendor, O Data are read and used to assess the survey results and select and tailor survey questions for the next cycle. So, these operational data sets are added to the data set that is being sent back.

Additional O Data defined by the survey designer are collected and presented to the user answering the survey, so the user can select or de-select that data to be sent back. This interaction with the survey also affords user the ability to consent to data provisioning and data analysis. Such consent transparency increases the willingness of users to share data, as they are aware of exactly what data is being sent and what data is not being sent.

Answers to survey questions are part of the same data package sent back to the survey application and then forwarded on to the vendor, in order to allow correlation.

Operational data which can be evaluated to configure the survey can be one or more of the following:
configuration data specifying the functional scope activated;
data volume (this determines a level of usage, e.g., as between “activated but never used”, “rarely used”, and “frequently used”);
data statistics and statistic ratios (e.g., object changed vs. object created; number of line items per header object—that is, whether there is always one item or only a few, or very large number of items).

One goal according to particular embodiments, is to engage with the software user in a personalized way to collect feedback and assessment about the software being evaluated. On the one hand, this allows the software development teams to ask detailed questions to precisely defined target audiences (e.g., “power users in the sales department working on certain transactions who do not use the new conversational AI but the traditional menu”).

On the other hand, users are not annoyed with generic questions about problems and topics they rarely experience during their use of the software. In this manner, the surveys can be better distributed to different groups of users, and the frequency of survey promulgation can be reduced.

Also, follow-up questions may be effectively sent to relevant users. Thus, a new iteration of the survey can be promulgated to the same group previously asked, based upon the analysis of the development team following the first survey cycle.

In order to achieve this, users may be identified, e.g.:
having certain roles,
having a certain management level and span of control,
casual users,
users who had been active the last x days (and have seen the latest version of the software), as well as users who had used the functionality under discussion just minutes ago.

Embodiments allow striking a balance between:
questions which can be directly related to actions the user performed (e.g., “why did you press this button?” which can feel being watched but allows to give context); and
questions that are too generic (e.g., “How do you rate user experience of our product?”).

If a survey is triggered when a process is completed, the user sees the context between “survey and data”. Accordingly, the user is likely more willing to send data, because the user understands the relation of data to the survey and what data is actually being sent (e.g., statistical information instead of concrete data values).

To enhance user acceptance, data can also be excluded from the package being sent back. This is a way to “opt-out” and creates the sense of voluntary cooperation that renders the user more comfortable with the process.

Another goal of certain embodiments is to adjust questions to the situation the user is actually facing. For example, if a survey question has a list of options to select from, the options can already be restricted to those options configured in the system. This makes the survey better linked to the software being evaluated, and avoids the thoughts of the user turning to the quality of the survey (undesired), rather than the quality of the software being evaluated (desired).

Usage patterns of individual consumers can be detected and taken as a starting point for survey questions. For example, a survey question may seek to usefully identify why a certain usage pattern is chosen (e.g., one differing from the usage pattern envisioned by the software designers).

According to one example, if an object is created and immediately changed, this can be detected from the system. The system can identify that the screen to create the object is missing input fields. In this manner the change/create ratio per object type, can serve as an interesting Key Performance Indicator (KPI) to evaluate and use to develop survey questions pertaining to software usability.

Another example relates to a “change request management system”. The system can determine how customers distribute software changes to change requests. It may be revealed that some customers follow a strategy “to bundle changes to few requests”, while other users do “one change per request”.

The underlying reason behind this behavior may be the audit system and process of the different users.

Accordingly, a survey could be tailored to identify this situation, and ask customers why they chose a certain usage pattern. In this manner, software developers can better understand the customer situation (here, by becoming aware of the influence of a second process unrelated to their product and thus not part of the product under survey).

Once the “change request management system” developers recognize this relation, they can extend their product accordingly. Such feedback would typically not be provided by users asked generic questions on “usability of the product”.

Thus, operational data of relevance can comprise one or more of:
statistics data about process data (not the process data themselves),
information about relations between data domains and cardinality statistics,
no person related data.

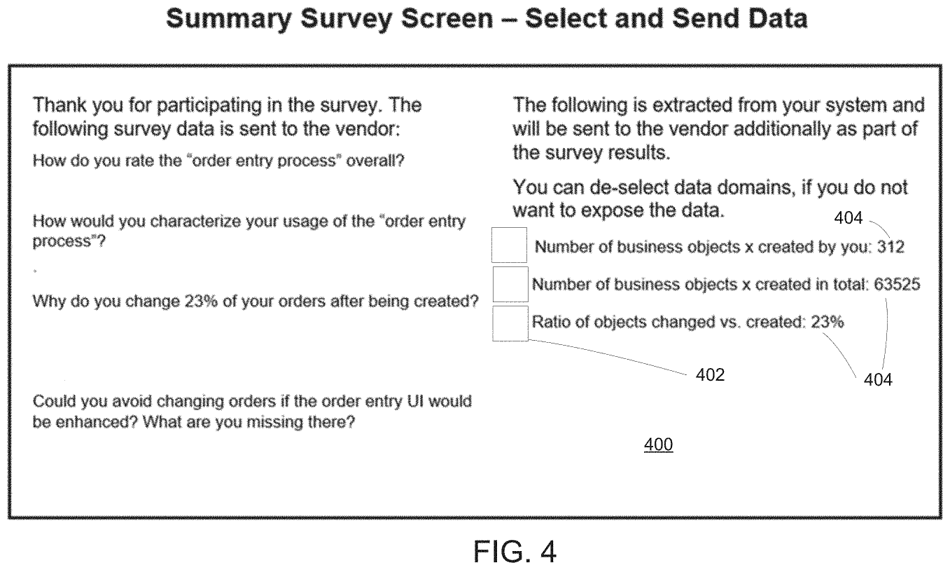

As mentioned above, a customer can select/de-select which O Data records are returned with each X Data feedback. FIG. 4 shows an unfilled summary survey screen 400. The check boxes 402 afford the user control over the particular relevant operations data 404 that would be returned with feedback.

Further details regarding this exemplary embodiment are now described. For the survey design and data collection cycle, from a consumption perspective the customer system connects to the survey marketplace at the software vendor in order to query for new surveys.

The X+O coordinator downloads the new surveys returned by the query, checks if these new surveys are applicable to this customer system, and decides whether or not to run the new surveys. The application determines the user group to ask (e.g., random users with a certain profile), adjusts the survey questions to the specifics of the customer system, and sends the tailored survey to the user group.

The following is one example for user group determination. Only users of a certain product feature are deemed relevant. Distribute the survey to different users of different departments. However, do not ask the same users as in previous surveys performed during the last four weeks (this is an “annoyance-threshold” to avoid overloading single users with too many surveys.)

The user is presented the “X+O survey service” and asked to give consent to running surveys in general (unless such consent was already given in a previous survey).

Note, for every survey it will still be possible for a user to decline participation, and to allow for removal of data from the feedback process.

The user completes the survey and is asked for consent to include collected O Data with the X-data from the survey and sends that data back to the software vendor. As shown in the filled-in survey screen 500 of FIG. 5, this consent can be in the form of checked boxes 502, which show the particular operational data 504 that is to be returned, e.g.:
three hundred and twelve objects were created by the survey respondent; and
the ratio of changed objects: objects created, is 23%.

In this particular example, it is worthy of note that the survey respondent has declined to consent to communication of the following operational data 506:
63525 total objects were created.

An example of a full process from survey design to submittal is now described in more detail in connection with the system 300 of FIG. 3.

1. The product manager 302 describes the survey goals to a survey designer 304. The survey designer creates a configuration package 306 for the next survey.

The configuration package may comprise one or more of:
survey questions,
O Data collection,
rules to apply to fine-tune the survey questions,
the survey target user group, and
the event triggering the survey for users.

This “survey config” is provided as a download package 306. The survey configuration is published, and an event that “new survey is available”, is sent.

2. Systems such as application 307 participating in the “X+O survey service”, download 308 the “survey config” upon receipt of the event. The X+O coordinator stores the new configuration from the download area, and adds the new survey to the survey queue 312.

3. The X+O coordinator reads the survey from the survey queues, reads the related survey config, and calls 314 the O-engine 316 with the configuration specifying which data to read. The O-engine calls 315 Application Program Interfaces (APIs) 317 or executes SQL statements to perform one or more of:
retrieve operational data,
compute statistics,
anonymize data, and
send relevant information back to the X+O coordinator.

4. The X+O coordinator calls 318 the X-engine 320 to compute the surveys. The X+O coordinator first assesses if the survey is shown at all.

The X+0 coordinator second determines the target user group based upon:
O-data selected, and
rules taken from the survey configuration and evaluated by the rules engine 326.

Third, the X+O coordinator computes the survey questions.

To compute the target user group, the survey history 330 is evaluated to either:
specify a target user group matching the user group of a previous survey (if this is configured by the designer), or
create a randomly selected user group excluding users having been presented several surveys in the past.
   This procedure is defined by the survey designer and executed by the rule engine.

The survey and the target user group are stored in the survey history 330. Then, the tailored survey 332 is shown to the consumers 334 at the event specified by the designer (e.g., “particular process completion event”; “UI used event”; a random time; other).

5. The consumers fill out the survey (or decline to do so), review the O-data presented which will be sent, and select/de-select the data records to send. Their consent is given to send the data package and for the vendor to evaluate the data.

6. When a defined minimum level of users have completed the survey or a defined maximum time is reached, the X+O coordinator creates the data package X+O Data 340, and sends 342 the package to the X+O data inbox 344 of the vendor. The inbox stores 346 the data 348 at the vendor side.

7. Once a certain amount of feedback has been received, the product manager(s) can review the survey results (X Data), run the correlation of X Data with O Data, and assess feedback. This assessment can allow the product managers to reach their conclusions on product development and/or create a new or follow-up survey.

Dynamic instrumentation to collect O Data is now described. Possible sources of O Data in the system are:
Data exposed via existing APIs in the system, such as,
   Monitoring data providers, anything fed to monitoring systems including DB statistics like DB table size, data histograms,
   Software catalog, set of deployed components especially extensions to the main product,
   Process configuration,
   Master data,
   Transactional data;
DB table direct access: in case there is no suitable interface to access the desired data, the DB can be accessed directly to compute—for example—the change/create ratio mentioned above

The O-data collection engine allows at least two approaches for data collection:
Definition in the configuration, which API to call, when/how often, how to parametrize;
   the data will be read and stored in O-data package ready to be transferred together with the X-data.
For data which is not exposed as an API, an SQL statement is provided and potentially a script computing statistical values and anonymizing data, basically defining an API for the data collectors;
   the SQL statement is executed with a user with read-only access permission, ensuring no side effects in the running software will occur by data extraction

Examples of survey creation in connection with a number of user environments, are now described. A first example of survey creation relates to process optimization.

Here, the vendor thinks about enhancement of the order entry process to increase the level of automation. For this, it shall be evaluated if the number of order changes in a customer system is higher than to be expected for the number of orders created. This could be an indication that the customer is manually post-processing orders due to lack of functionality, but it is unclear what this functionality might be and if new functionality would be helpful at all or if the high number of order changes is just because this customer's buyers often change their mind.

Only customers that show the outlined characteristics (high number of order changes compared to number of orders created, as read from O-Data) will be presented with a survey asking them about the reasons.

Additionally, operational data is collected about the affected order objects. Sample operational data may be as follows:
Ratio of orders changed/all orders
Time lapse between order created and order changed (min/max/avg)
Who changed the orders compared to who created them (same user/users from same or different team (read from org-model))
What was changed (fields, header, line items, . . . )
Was the order object extended by custom fields and were those the fields that were post-processed

Sample survey questions and answers based upon X-Data are as follows.
“Why do you change xxx % of your orders after being created?”
Answer: “The object creation screen does not show all relevant options to enter content, i.e. customer extension fields like ‘coupon code’”
“Do you think the changes you perform could be automated? How?”
Answer: Yes, add customer extension fields to “create screen”.
“How much effort is it to post-process these orders? How much time/money could you save by automation?”
Answer: It is adding about 5 min per order. I could do 50% orders more per hour, if I would have an improvement.
“Could you avoid changing orders if the order entry UI would be enhanced? What are you missing there?”
Answer: Additional fields like ‘coupon code’ should be editable on the order entry screen, not only accessible in a separate UI after the order was created.

Apprised of this information, the vendor obtains a comprehensive understanding of the potential benefit of an enhancement, and also in what direction this enhancement would need to go. The collected O-Data supports this information with technical details (like custom fields) that the user typically is not even aware about.

Another example of survey creation relates to use scope, and implementation project problems. Specifically, while download and deploy statistics for software can be created rather easily, it becomes more difficult to ascertain whether certain product or tool features are in use and their success.

Reaching such conclusions may require additional data extraction. What is rather hard to determine are problems that are encountered in an implementation project: how long did it take? what had been the problems? why was an implementation project stopped?

If answers to such questions are to be determined, the X+O coordinator may run in a platform or management system. This allows the process to work even if the application is not yet deployed.

O-data that is relevant to a survey in this context, can be:
[symbol] System landscape and deployed components
[symbol] Business configuration for processes and technical configuration for tools
[symbol] Statistical data on the feature under consideration, like “number of data records created”, “number of runs of a tool”, “runtime statistics including performance”. X-Data
[symbol] “You downloaded the app, but did not deploy it, can you tell us the reasoning behind?”
[symbol] “You configured process xxx/tool features yyy, usage statistics shows . . . (e.g. rare use initially and no use since some weeks) what feature or function do you miss?”
[symbol] “You configure feature yyy, the runtime statistics show an improvement of . . . in runtime. Did this function meet your expectations?”

With survey questions, product manager can also identify strategic considerations of the customer, or constraints imposed by company regulations or standards, which cannot necessarily be apparent from data accessible to the O-data engine. These considerations may have a strong impact on the evolution of an application. X-data is thus critical in this aspect.

Yet another specific example of survey creation can arise under the customer IT environment. Specifically, vendors want to know the environment where their products are deployed and operated. For products with a longer lifecycle, it can even be the case that the environment is newer than the product—e.g., a container environment of Infrastructure as a Service (IaaS).

If a vendor knows the mainstream environment and the variability, a new product version can be designed to better fit this environment/take advantage of the environment. This information may influence whether the vendor even considers to provide services on a certain IaaS offering to improve performance and user experience.

Data that is relevant in this customer IT context can be as follows:
[symbol] Operational environment (as far as it can be read from the O-engine)
[symbol] Performance data, especially related to the compute environment (provided CPU, RAM, GPU)
[symbol] Service call statistics and response time statistics

X Data that is relevant in this customer IT context can be as follows:
[symbol] Query of environment data, that could not be read by the 0 engine
[symbol] “Are you satisfied with the performance (average response time of your application is on the order of milli seconds)?”
[symbol] Why did you choose this environment to run the application? [company strategy, existing contracts, price, region, availability of services in the environment, other]

For example, not all platform services are available on all hyperscalers. If a customer chooses one hyperscaler, this might impact user experience. The results of inquiring why this customer chose the particular hyperscaler can be interesting for the vendor to potentially adjust the offering of their backend services (e.g., deploy on additional hyperscaler, and/or region, and/or environment).

A further illustrative example involves a data volume context. In the process of migrating customers from the Enterprise Resource Planning (ERP) application available from SAP SE of Walldorf, Germany, and the SAP S/4HANA platform, data volume in certain tables may be important to know.

This data volume impacts the duration of the migration, and potentially requires additional strategies and tool optimizations at SAP. As the new product S/4HANA has been designed after customers have already deployed ERP, the data extractors part of ERP may not deliver all information developers of S/4HANA and the migration tool would like to know.

Certain tables are known to be migrated by the developers. Not only the data volume, but also data statistics, histograms, and key significance are interesting in the design of parallelism.

The O-Data relevant to such a data volume context can be as follows.
[symbol] Data volume, data growth rate, data archiving rate per table being specified.
[symbol] Business configuration related to the processes using these tables (e.g. customer-vendor integration to BuPa already done or not)
[symbol] Key significance and data histogram for the tables.
[symbol] Number of application servers, available Ram, number of configured work processes
[symbol] If a test upgrade ran already
Upgrade runtime statistics and upgrade configuration especially on parallelization
[symbol] Related to downtime prediction and configuration recommendation tool
Data the tool reads to compute the prediction/recommendation
prediction/recommendation results

The X Data relevant to such a data volume context can be as follows.
[symbol] Does the expected downtime meet your expectations?
[symbol] Did you optimize the procedure additionally compared to the available configurations?
[symbol] Depending on the archiving statistics read:
Can you archive more data?/Why do you not archive data?
[symbol] Are you satisfied with the prediction/recommendation? What would you require in addition?
If the survey is “post-migration” the prediction accuracy is known and can be used to shape the question:
The prediction was only accurate to 40%, was this sufficient for you to plan the project?
The prediction was accurate to 10%, how do you rate the usefulness of the information provided?

In this context, the feedback data from the survey can be used to optimize the migration procedure and tools for the next version of S/4HANA that is to be published.

Returning now to FIG. 1, while that figure shows the survey engine as being external to the storage medium responsible for storing operational data of the software being evaluated, this is not required. Particular embodiments could leverage the processing power of an in-memory database engine to perform one or more tasks. For example, the same powerful processing engine of a SAP HANA in-memory database responsible for storing software operational data, could be leveraged to perform one or more tasks of the survey engine (e.g., store and reference a received configuration file in order determine target user groups for a survey).

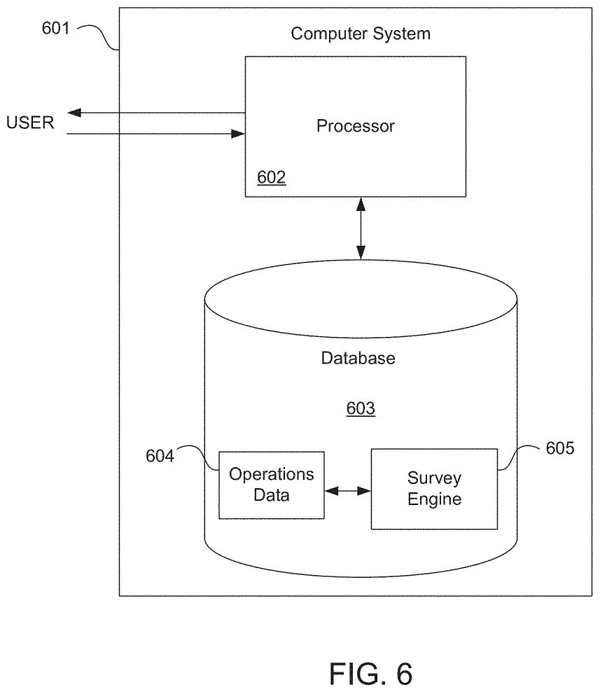

Accordingly, FIG. 6 illustrates hardware of a special purpose computing machine configured to implement a survey result and analysis cycle according to an embodiment. In particular, computer system 601 comprises a processor 602 that is in electronic communication with a non-transitory computer-readable storage medium comprising a database 603. This computer-readable storage medium has stored thereon code 605 corresponding to a survey engine. Code 604 corresponds to operational data. Code may be configured to reference data stored in a database of a non-transitory computer-readable storage medium, for example as may be present locally or in a remote database server.

Software servers together may form a cluster or logical network of computer systems programmed with software programs that communicate with each other and work together in order to process requests.

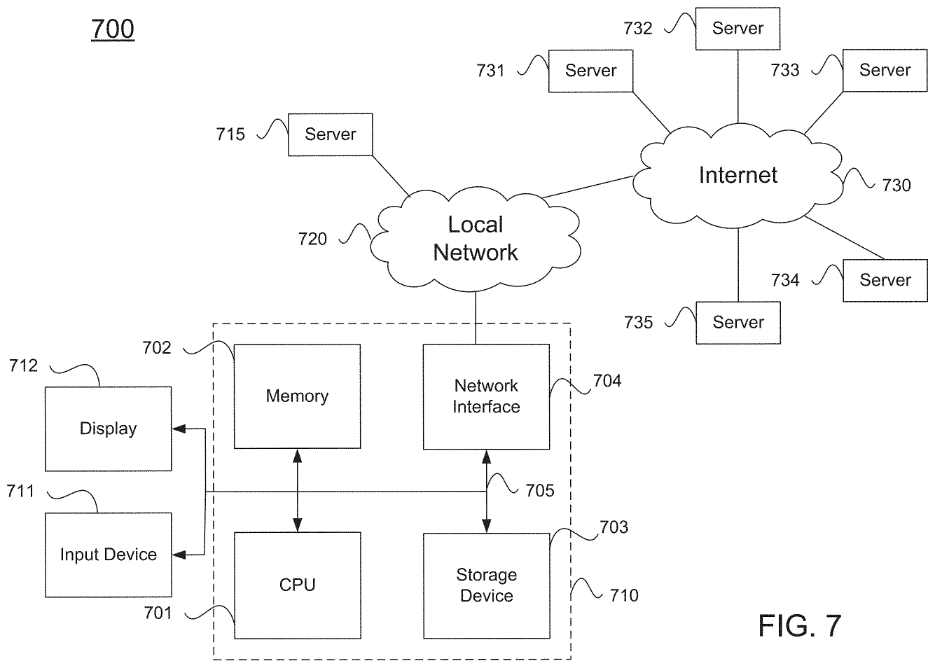

An example computer system 700 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a Light Emitting Diode (LED) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 1605. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 1604 to a component on computer system 710. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving from a survey designer, a configuration file specifying,
a survey question regarding a software application,
a type of operations data of the software application relevant to the survey question, and
a user of the software application;
referencing the type and the user to retrieve operations data of the software application;
promulgating to the user, a survey including the survey question and the operations data;
receiving from the user, a survey response including an answer to the survey question and a consent;
storing a package comprising the survey question, the survey response, and the operations data in a non-transitory computer readable storage medium; and
communicating the package as feedback to a manager of the software application.

2. A method as in claim 1 wherein the configuration further comprises a rule, the method further comprising:
processing the rule to define a user group including the user;
promulgating the survey to the user group;
receiving from the user group, answers to the survey question, respective consents, and respective operations data; and
storing the answers to the survey question and the respective operations data as part of the package.

3. A method as in claim 2 wherein processing the rule considers one or more criteria selected from:
utilization of a particular functionality of the software application;
creation of data in the software application;
change of data in the software application;
a survey history;
a version;
a role; and
an organization chart.

4. A method as in claim 1 wherein:
the configuration file further includes an event;
the software application communicates the event; and
promulgation of the survey is triggered by the event.

5. A method as in claim 1 wherein:
the consent specifically references a portion of the operations data; and
storing the package includes storing only the portion of the operations data.

6. A method as in claim 1 further comprising storing the survey and the survey response in a survey history.

7. A method as in claim 1 wherein the package is communicated as feedback to the manager of the software application upon the occurrence of:
a defined minimum level of users completing the survey; or
a defined maximum time being reached.

8. A method as in claim 1 wherein:
the non-transitory computer readable storage medium comprises an in-memory database; and
retrieving the operations data comprises an in-memory database engine of the in-memory database retrieving the operations data from the in-memory database.

9. A non-transitory computer readable storage medium embodying a computer program for performing a method, said method comprising:
receiving from a survey designer, a configuration file specifying,
a survey question regarding a software application,
a type of operations data of the software application relevant to the survey question,
a user of the software application, and
an event;
referencing the type and the user to retrieve operations data of the software application;
in response to publication of the event in the software application, promulgating to the user, a survey including the survey question and the operations data;
receiving from the user, a survey response including an answer to the survey question and a consent;
storing a package comprising the survey question, the survey response, and the operations data in a non-transitory computer readable storage medium; and
communicating the package as feedback to a manager of the software application.

10. A non-transitory computer readable storage medium as in claim 9 wherein the method further comprises:
processing the rule to define a user group including the user;
promulgating the survey to the user group;
receiving from the user group, answers to the survey question, respective consents, and respective operations data; and
storing the answers to the survey question and the respective operations data as part of the package.

11. A non-transitory computer readable storage medium as in claim 10 wherein processing the rule considers one or more criteria selected from:
utilization of a particular functionality of the software application;
creation of data in the software application;
change of data in the software application;
a survey history;
a version;
a role; and
an organization chart.

12. A non-transitory computer readable storage medium as in claim 9 wherein the method further comprises storing the survey and the survey response in a survey history.

13. A non-transitory computer readable storage medium as in claim 9 wherein the consent specifically references a portion of the operations data; and
storing the package includes storing only the portion of the operations data.

14. A non-transitory computer readable storage medium as in claim 9 wherein:
the non-transitory computer readable storage medium comprises an in-memory database; and
retrieving the operations data comprises an in-memory database engine of the in-memory database retrieving the operations data from the in-memory database.

15. A computer system comprising:
one or more processors;
a software program, executable on said computer system, the software program configured to cause an in-memory database engine of an in-memory database to:
receive from a survey designer, a configuration file specifying,
a survey question regarding an application,
a type of operations data of the software application relevant to the survey question, and
a user of the application;
reference the type and the user to retrieve operations data of the application;
promulgate to the user, a survey including the survey question and the operations data;
receive from the user, a survey response including an answer to the survey question and a consent;
store a package comprising the survey question, the survey response, and the operations data in the in-memory database; and
communicate the package as feedback to a manager of the application.

16. A computer system as in claim 15 wherein the configuration further comprises a rule, the in-memory database engine configured to:
process the rule to define a user group including the user;
promulgate the survey to the user group;
receive from the user group, answers to the survey question, respective consents, and respective operations data; and
store the answers to the survey question and the respective operations data as part of the package.

17. A computer system as in claim 16 wherein processing the rule considers one or more criteria selected from:
utilization of a particular functionality of the software application;
creation of data in the software application;
change of data in the software application;
a survey history;
a version;
a role; and
an organization chart.

18. A computer system as in claim 15 wherein:
the configuration file further includes an event;
the software application communicates the event; and
promulgation of the survey is triggered by the event.

19. A computer system as in claim 15 wherein the package is communicated as feedback to the manager of the software application upon the occurrence of:
a defined minimum level of users completing the survey; or
a defined maximum time being reached.

20. A computer system as in claim 15 further comprising the in-memory database engine storing the survey and the survey response in a survey history.
